(19) United States
(12) Patent Application Publication
(10) Pub. No.: US 2004/0187466 A1
(43) Pub. Date: Sep. 30, 2004

(54) Field coring apparatus and method

(76) Inventors: Jose Luis Garcia, JR., Yuma, AZ (US); Carlos Alonzo, Yuma, AZ (US)

Correspondence Address: WEISS & MOY PC, 4204 NORTH BROWN AVENUE, SCOTTSDALE, AZ, 85251, US

(21) Appl. No.: 10/378,145

(22) Filed: Mar. 4, 2003

(51) Int. Cl. A01D 46/00

(52) U.S. Cl. 56/328.1

(57) ABSTRACT

A produce harvesting and coring apparatus and method, which facilitates the harvesting and coring of produce in a field setting. In a preferred embodiment, a plurality of coring devices having automated coring elements are affixed to a side portion of an elongated harvesting apparatus, between work tables. A clean and core operator may then take an item of harvested produce and core it using the coring device, before placing the cored item of produce onto the elongated harvesting apparatus. The coring device preferably operates by placing an item of produce in a basket and moving the basket (with the produce therein) in a downward direction, permitting the cutting element to penetrate and remove the core of the item of produce.

### BACKGROUND OF THE INVENTION

1. Field of Invention

This invention relates generally to apparatuses and methods for coring harvested produce and, more particularly, to an apparatus and method for coring harvested produce in a field setting.

2. Background of the Invention

The harvesting of certain types of produce, including for example varieties of cabbage, is typically accomplished manually. In a manual harvesting operation, a person (generally referred to as a “cutter”) will, using a special cutting tool, cut the produce head from the root portion, so that it may be removed from the ground. Where a mobile harvesting apparatus. is utilized for further transport and/or processing of harvested produce, it may be the case that an additional worker will take the harvested produce, core it manually using a hand-held cutting tool, and place it on the harvesting apparatus. Alternatively, the produce may be harvested in the field but not cored, and then cored in a processing facility that is remote from the field.

There are several drawbacks with prior art methods. Where coring is accomplished manually in the field, that process can be relatively time consuming. Moreover, the use of a knife to perform the coring operation can result in injury to the person performing such an operation. On the other hand, where coring is conducted in a remote processing facility, the efficiency of performing the coring incident to the harvesting process and in the field setting is lost.

A need therefore existed for a harvesting apparatus that permits automated produce coring, in the field, in a. manner that is safer than prior art fully manual methods. The present invention satisfies these needs and provides other, related, advantages.

### SUMMARY OF THE INVENTION

It is an object of the present invention to provide an improved apparatus and method for coring harvested produce in a field setting.

It is a further object of the present invention to provide an improved apparatus and method for coring harvested produce in a substantially automated way in a field setting.

### BRIEF DESCRIPTION OF THE PREFERRED EMBODIMENTS

In accordance with one embodiment of the present invention, a produce harvesting and coring apparatus is disclosed. The apparatus comprises, in combination: a harvesting apparatus; and at least one coring device having a powered coring element coupled to the harvesting apparatus.

In accordance with another embodiment of the present invention, a method for coring produce in a field setting is disclosed. The method comprises the steps of: providing a harvesting apparatus in a field to be harvested; providing at least one coring device having a powered coring element coupled to the harvesting apparatus; harvesting an item of produce from a field; and coring the item of produce on the at least one coring device while the harvesting apparatus is positioned in the field to be harvested.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a perspective view of an embodiment of a coring device consistent with the present invention.

FIG. 2 is a side view of the device of FIG. 1, illustrating the movement of the apparatus when a coring operation is performed.

FIG. 3 is a top view of the device of FIG. 1.

FIG. 4 is a perspective view of the cutting element of the device of FIG. 1.

FIG. 5 is a top view of an embodiment of a harvesting apparatus having a coring device thereon.

FIG. 6 is a side view of the harvesting apparatus of FIG. 5.

### DETAILED DESCRIPTION OF THE PREFERRED EMBODIMENTS

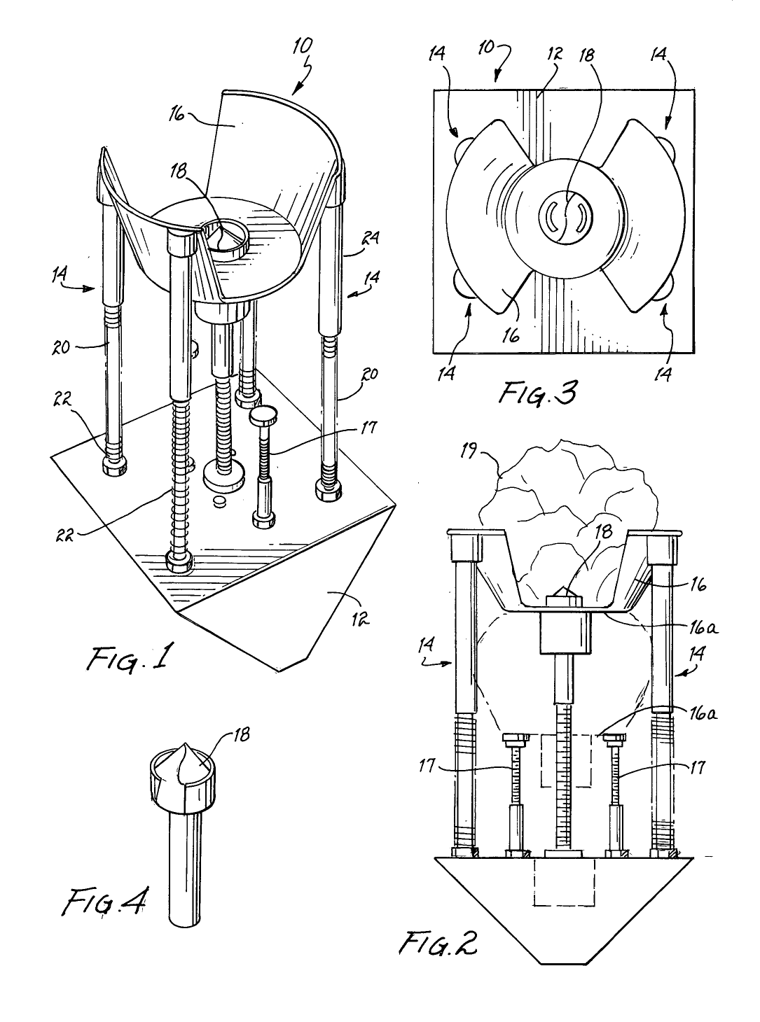

Referring to FIGS. 1-3, a coring device 10 is consistent with the present invention is shown. The coring device 10 preferably comprises a base portion 12, to which is affixed a plurality of spring-loaded supports 14. (While four supports 14 are shown, it should be understood that a greater or lesser number of supports 14 could be provided.) The supports 14 support a produce basket 16, having a coring bit 18 projecting through a bottom portion thereof. The produce basket 16 is dimensioned to receive an item of produce 19 therein. (Preferably, the item of produce 19 is cabbage, though other items of produce, such as lettuce, may also be cored with the coring device 10 of the present invention.) Below the basket 16 is positioned at least one and preferably two stops 17. The individual components and their operation will now be treated in greater detail.

Turning first to the spring-loaded supports 14, these preferably consist of a center post 20 which is coupled at a superior end thereof to the base portion 12. Over a lower portion of the center post 20 is positioned a spring 22. The topmost portion of the spring 22 contacts a sleeve 24, which is slidably retained on the center post 20 above the spring 22. Downward pressure on the sleeve 24 causes contraction of the spring 22, such that the release of such pressure will cause the sleeve 24 to move upward to its original position on the center post 20.

With specific regard to the stops 17, these preferably comprise upwardly extending posts that are adjustable in height. Such adjustability can be provided by, for example, providing a stop 17, as shown in FIGS. 1 and 2, in which a superior threaded shaft is received within a mating threaded shaft, such that rotation of the threaded shaft in one direction will increase the height of the stop 17, and rotation in the opposite direction will decrease its height.

Referring now to FIG. 4, attention is directed to the coring bit 18. The cording bit 18 projects through an opening in the base of the basket 16. While the length of the coring bit 18 may be adjustable, in operation, it remains of fixed length—so that depression of the basket 16 causes the position of the coring bit 18 to become raised relative to the base 16a of the basket 16, as illustrated in FIG. 2. The coring bit 18 comprises a cutting surface that is adapted to cut away the core of an item of produce 17, when the coring bit 18 is rotated and brought into contact with the produce 17 core. Rotational force is imparted through any desired automated means, with hydraulic power being preferred.

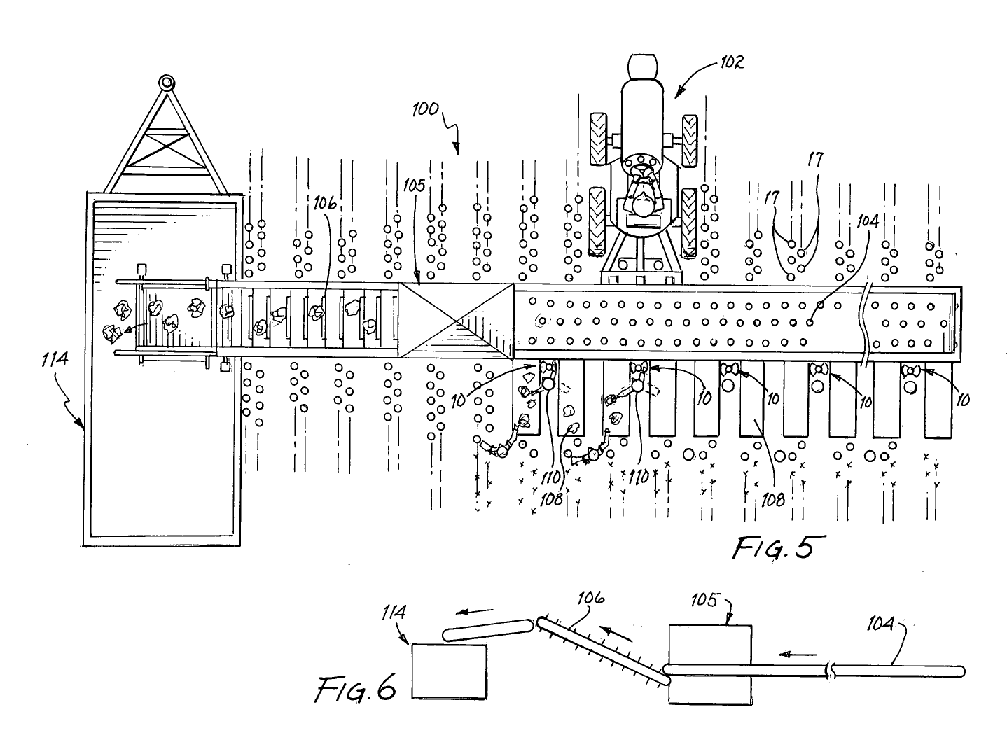

Referring now to FIGS. 5-6, a harvesting apparatus 100 having a plurality of coring devices 10 thereon is shown. The harvesting apparatus 100 is preferably towed by a trailer 102, though the harvesting apparatus 100 could be self-propelled. The harvesting apparatus 100 preferably comprises a horizontal conveyor 104, leading to an elevated conveyor 106.

Projecting outward from the horizontal conveyor 104 are a plurality of work tables 108. These work tables 108 should be spaced far enough apart to permit at least one clean and core person 110 to stand therebetween. The surface of the work tables 108, which are expected to come into contact with the harvested produce, should be stainless steel, for greater food safety. Coupled to the side of the apparatus 100, preferably between work tables 108, are coring devices 10.

As shown in FIG. 1, behind the clean and core persons 110 will preferably be a row of cutters 112. The role of the cutters 112 is to harvest the produce 17 from the ground, typically with a knife of some kind. After harvesting, the cutter 112 places the produce 17 on a work table 108 from where it can be taken by a clean and core person 110 or, optionally, hands it directly to a clean and core person 110.

The clean and core person 110 will then grasp the produce 17, place it into the basket 17 (as shown in FIG. 2), and press downward while the coring bit 18 is rotating (or with such downward force activating rotation of the coring bit 18). The clean and core operator 110 should continue to press down until the base 16a of the basket 16 contacts the stops 17.

Such downward motion of the basket 16 brings the core of the produce 17 into contact with the coring bit 18. Rotation of the coring bit 18 causes a cutting away of the core area of the produce 17, with the core being reduced to small pieces that fall into the basket 16. Because the basket 16 is preferably open on two sides (see FIGS. 1-3), the pieces fall through these openings and onto the ground.

It will be desired to adjust the height of the stops 17 so that, for the particular size of the produce 17 that is being harvested, the coring bit 18 will project sufficiently upward to remove the core, but not so high as to penetrate the exterior of the produce 17.

After coring, the clean and core operator 110 then removes the cored produce 17 from the basket 16, allowing the basket 16 to spring to its original position. The clean and core operator 110 then places the cored produce 17 on the horizontal conveyor 104. It will travel to the right (see FIG. 2) and may pass through an optional washing station 105. Thereafter, the produce 17 enters an elevated conveyor 106, from where it is ultimately loaded into a bin 114 or other desired loading location.

While the invention has been particularly shown and described with reference to preferred embodiments thereof, it will be understood by those skilled in the art that the foregoing and other changes in form and details may be made therein without departing from the spirit and scope of the invention. For example, it should be noted that the coring process as outlined herein could be made more fully automated, by providing means for automatically depressing the basket 16 when an item of produce 17 is positioned therein—so that it will not be necessary for a clean and core person 110 to manually depress the basket 16. It may also be desired to provide a lid or other covering over the produce 17 when in position on the basket 16, to maintain the produce 17 in a constant position and to reduce the risk that the coring bit 18 could come into contact with the hand of a clean and core person 110.

I claim:

1. A produce harvesting and coring apparatus comprising, in combination:
a harvesting apparatus; and
at least one coring device having a powered coring element coupled to the harvesting apparatus.

2. The produce harvesting and coring apparatus of claim 1
wherein the harvesting apparatus is elongated, and includes a horizontal conveyor, and wherein the at least one automated coring device is coupled proximate a side of the horizontal conveyor.

3. The produce harvesting and coring apparatus of claim 2 further comprising a plurality of work tables projecting outward from a side of the horizontal conveyor, with the at least one automated coring device being located between two the work tables.

4. The produce harvesting and coring apparatus of claim 1 wherein the coring device comprises a basket supported by at least one spring-loaded support and having a coring bit adapted to project through an opening in a base of the basket.

5. The produce harvesting and coring apparatus of claim 4 wherein the basket has at least one open side to permit core cuttings to exit the basket.

6. The produce harvesting and coring apparatus of claim 5 wherein the basket has two the open sides.

7. The produce harvesting and coring apparatus of claim 4 further comprising at least one stop positioned below the base of the basket and adapted to limit downward motion of the basket.

8. The produce harvesting and coring apparatus of claim 7 comprising two the stops.

9. The produce harvesting and coring appartus of claim 7 wherein a height of the at least one step is adjustable.

10. A method for coring produce in a field setting comprising the steps of:
providing a harvesting apparatus in a field to be harvested;
providing at least one coring device having a powered coring element coupled to the harvesting apparatus;
harvesting an item of produce from a field; and
coring the item of produce on the at least one coring device while the harvesting apparatus is positioned in the field to be harvested.

11. The method of claim 10 wherein the harvesting apparatus is elongated, and includes a horizontal conveyor, and wherein the at least one automated coring device is coupled proximate a side of the horizontal conveyor.

12. The method of claim 11 further comprising the step of providing a plurality of work tables projecting outward from a side of the horizontal conveyor, with the at least one automated coring device being located between two the work tables.

13. The method of claim 10 wherein the coring device comprises a basket supported by at least one spring-loaded support and having a coring bit adapted to project through an opening in a base of the basket.

14. The method of claim 13 wherein the basket has at least one open side to permit core cuttings to exit the basket.

15. The method of claim 14 wherein the basket has two the open sides.

16. (not entered)

17. The method of claim 13 further comprising at least one stop positioned below the base of the basket and adapted to limit downward motion of the basket.

18. The method of claim 17 comprising two the stops.

19. The method of 17 wherein a height of the at least one step is adjustable.

20. The method of claim 13 further comprising the steps of:
placing the item of produce in the basket;
moving the basket in a downward direction;
the coring element coring the item of produce;
removing the item of produce from the basket; and
the basket moving in an upward direction.
